(19) United States
(12) Patent Application Publication
(10) Pub. No.: US 2015/0168296 A1
(43) Pub. Date: Jun. 18, 2015

(54) SHORT OPTICAL PULSE GENERATOR, TERAHERTZ WAVE GENERATOR, CAMERA, IMAGING APPARATUS, AND MEASUREMENT APPARATUS

(71) Applicant: SEIKO EPSON CORPORATION, Tokyo (JP)

(72) Inventor: Hitoshi NAKAYAMA, Chino-shi (JP)

(21) Appl. No.: 14/574,069

(22) Filed: Dec. 17, 2014

(30) Foreign Application Priority Data
Dec. 18, 2013 (JP) 2013-261389

(51) Int. Cl. G01N 21/3581; G02B 13/00; G21K 5/04

(52) U.S. Cl. CPC G01N 21/3581; G21K 5/04; G02B 13/00; G21K 1/02

(57) ABSTRACT

A short optical pulse generator includes: an optical pulse generation unit which generates an optical pulse; a frequency chirping unit which chirps the frequency of the optical pulse; and a group velocity dispersion unit which produces a group velocity difference according to wavelength in the optical pulse chirped by the frequency chirping unit, wherein the group velocity dispersion unit includes a group velocity dispersion medium on which the optical pulse chirped by the frequency chirping unit is incident, and a first reflection mirror and a second reflection mirror which are provided with the group velocity dispersion medium sandwiched therebetween, and the optical pulse incident on the group velocity dispersion medium is reflected by the first reflection mirror and the second reflection mirror multiple times and travels in the group velocity dispersion medium.

### BACKGROUND

1. Technical Field

The present invention relates to a short optical pulse generator, a terahertz wave generator, a camera, an imaging apparatus, and a measurement apparatus.

2. Related Art

In recent years, a terahertz wave which is an electromagnetic wave having a frequency equal to or greater than 100 GHz and equal to or less than 30 THz has been attracting attention. The terahertz wave can be used in, for example, imaging, various measurements, such as spectroscopic measurement, nondestructive inspection, and the like.

A terahertz wave generator which generates the terahertz wave has, for example, a short optical pulse generator which generates an optical pulse having a pulse width of about a subpicosecond (hundreds of femtoseconds), and a photoconductive antenna which generates a terahertz wave when irradiated with the optical pulse generated by the short optical pulse generator. In general, as the short optical pulse generator which generates an optical pulse having a pulse width of about a subpicosecond, a femtosecond fiber laser, a titanium sapphire laser, a semiconductor laser, or the like is used.

For example, JP-A-11-40889 describes an optical pulse generator which directly modulates a semiconductor laser to chirp the frequency of an optical pulse and then compresses a pulse width by an optical pulse compression unit (group velocity dispersion unit) having a fiber.

However, in the optical pulse generator of JP-A-11-40889, since the semiconductor laser is directly modulated to chirp the frequency of the optical pulse, the chirp quantity is small, and the pulse width cannot be sufficiently compressed in the group velocity dispersion unit.

### SUMMARY

An advantage of some aspects of the invention is that it provides a short optical pulse generator capable of generating an optical pulse with a small pulse width. Another advantage of some aspects of the invention is that it provides a terahertz wave generator, a camera, an imaging apparatus, and a measurement apparatus including the short optical pulse generator.

A short optical pulse generator according to an aspect of the invention includes an optical pulse generation unit which generates an optical pulse, a frequency chirping unit which chirps the frequency of the optical pulse, and a group velocity dispersion unit which produces a group velocity difference according to wavelength in the optical pulse chirped by the frequency chirping unit. The group velocity dispersion unit includes a group velocity dispersion medium on which the optical pulse chirped by the frequency chirping unit is incident, and a first reflection mirror and a second reflection mirror which are provided with the group velocity dispersion medium sandwiched therebetween. The optical pulse incident on the group velocity dispersion medium is reflected by the first reflection mirror and the second reflection mirror multiple times and travels in the group velocity dispersion medium.

In the short optical pulse generator, the optical pulse can be chirped in the frequency chirping unit. Accordingly, for example, it is possible to increase the chirp quantity of the optical pulse and to sufficiently compress the pulse width in the group velocity dispersion unit compared to a case where there is no frequency chirping unit. Therefore, the short optical pulse generator can generate an optical pulse with a small pulse width.

In the short optical pulse generator, since the optical pulse incident on the group velocity dispersion medium is reflected by the first reflection mirror and the second reflection mirror multiple times and travels in the group velocity dispersion medium, it is possible to reduce the group velocity dispersion unit in size. For example, even when a group velocity dispersion value per unit length of the group velocity dispersion medium is small, the number of reflections of the optical pulse in the first reflection mirror and the second reflection mirror increases, whereby it is possible to increase the group velocity dispersion value of the group velocity dispersion unit.

In the short optical pulse generator according to the aspect of the invention, antireflection films may be provided on an optical pulse incidence surface of the group velocity dispersion medium and an optical pulse emission surface of the group velocity dispersion medium.

In the short optical pulse generator with this configuration, it is possible to reduce the reflectance of the optical pulse on the optical pulse incidence surface of the group velocity dispersion medium and the optical pulse emission surface of the group velocity dispersion medium.

The short optical pulse generator according to the aspect of the invention may further include a variable mechanism which changes the incidence angle of the optical pulse to the first reflection mirror.

In the short optical pulse generator with this configuration, it is possible to change the number of reflections of the optical pulse in the first and second reflection mirrors. As a result, in the short optical pulse generator, it is possible to change the group velocity dispersion value of the group velocity dispersion unit. With this, it is possible to change the pulse width of the optical pulse generated by the short optical pulse generator.

The short optical pulse generator according to the aspect of the invention may further include a collimator lens which converts the optical pulse incident on the group velocity dispersion medium to parallel light.

In the short optical pulse generator with this configuration, it is possible to suppress the spread of the optical pulse incident on the group velocity dispersion medium.

In the short optical pulse generator according to the aspect of the invention, the group velocity dispersion medium may be a glass substrate.

In the short optical pulse generator with this configuration, it is possible to achieve reduction in cost. The glass substrate does not extremely absorb the optical pulse generated by the optical pulse generation unit. For this reason, in the short optical pulse generator, it is possible to suppress a decrease in intensity of the optical pulse in the group velocity dispersion medium.

A terahertz wave generator according to another aspect of the invention includes the short optical pulse generator according to the aspect of the mention, and a photoconductive antenna which generates a terahertz wave when irradiated with a short optical pulse generated by the short optical pulse generator.

The terahertz wave generator can include the short optical pulse generator capable of generating an optical pulse with a small pulse width.

A camera according to still another aspect of the invention includes the short optical pulse generator according to the aspect of the invention, a photoconductive antenna which generates a terahertz wave when irradiated with a short optical pulse generated by the short optical pulse generator, a terahertz wave detection unit which detects the terahertz wave emitted from the photoconductive antenna and transmitted through an object or the terahertz wave reflected by the object, and a storage unit which stores the detection result of the terahertz wave detection unit.

The camera can include the short optical pulse generator capable of generating an optical pulse with a small pulse width.

An imaging apparatus according to yet another aspect of the invention includes the short optical pulse generator according to the aspect of the invention, a photoconductive antenna which generates a terahertz wave when irradiated with a short optical pulse generated by the short optical pulse generator, a terahertz wave detection unit which detects the terahertz wave emitted from the photoconductive antenna and transmitted through an object or the terahertz wave reflected by the object, and an image forming unit which forms the image of the object based on the detection result of the terahertz wave detection unit.

The imaging apparatus can include the short optical pulse generator capable of generating an optical pulse with a small pulse width.

A measurement apparatus according to still yet another aspect of the invention includes the short optical pulse generator according to the aspect of the invention, a photoconductive antenna which generates a terahertz wave when irradiated with a short optical pulse generated by the short optical pulse generator, a terahertz wave detection unit which detects the terahertz wave emitted from the photoconductive antenna and transmitted through an object or the terahertz wave reflected by the object, and a measurement unit which measures the object based on the detection result of the terahertz wave detection unit.

The measurement apparatus can include the short optical pulse generator capable of generating an optical pulse with a small pulse width.

### BRIEF DESCRIPTION OF THE DRAWINGS

The invention will be described with reference to the accompanying drawings, wherein like numbers reference like elements.

FIG. 1 is a functional block diagram of a short optical pulse generator according to an embodiment.

FIG. 2 is a diagram schematically showing the short optical pulse generator according to the embodiment.

FIG. 3 is a perspective view schematically showing a light emitting element of an optical pulse generation unit and an optical waveguide of a frequency chirping unit in the short optical pulse generator according to the embodiment.

FIG. 4 is a sectional view schematically showing the light emitting element of the optical pulse generation unit and the optical waveguide of the frequency chirping unit in the short optical pulse generator according to the embodiment.

FIG. 5 is a graph showing an example of an optical pulse generated by the optical pulse generation unit.

FIG. 6 is a graph showing an example of the chirp characteristic of the frequency chirping unit.

FIG. 7 is a graph showing an example of an optical pulse generated by a group velocity dispersion unit.

FIG. 8 is a diagram schematically showing a short optical pulse generator according to a first modification example of the embodiment.

FIG. 9 is a diagram schematically showing a model for describing the relationship between the incidence angle of an optical pulse to a reflection mirror and a group velocity dispersion value.

FIG. 10 is a graph showing the relationship between the incidence angle of the optical pulse to the reflection mirror and the group velocity dispersion value.

FIG. 11 is a diagram schematically showing a short optical pulse generator according to a second modification example of the embodiment.

FIG. 12 is a diagram showing the configuration of a terahertz wave generator according to the embodiment.

FIG. 13 is a block diagram showing an imaging apparatus according to the embodiment.

FIG. 14 is a plan view schematically showing a terahertz wave detection unit of the imaging apparatus according to the embodiment.

FIG. 15 is a graph showing a spectrum in a terahertz band of an object.

FIG. 16 is a diagram of an image representing the distribution of substances A, B, and C of an object.

FIG. 17 is a block diagram of a measurement apparatus according to the embodiment.

FIG. 18 is a block diagram showing a camera according to the embodiment.

FIG. 19 is a perspective view schematically showing the camera according to the embodiment.

### DESCRIPTION OF EXEMPLARY EMBODIMENTS

Hereinafter, a preferred embodiment of the invention will be described in detail referring to the drawings. It should be noted that the following embodiment is not intended to unduly limit the content of the invention described in the appended claims. The entire configuration described in the embodiment is not necessarily the essential components of the invention.

### 1. SHORT OPTICAL PULSE GENERATOR

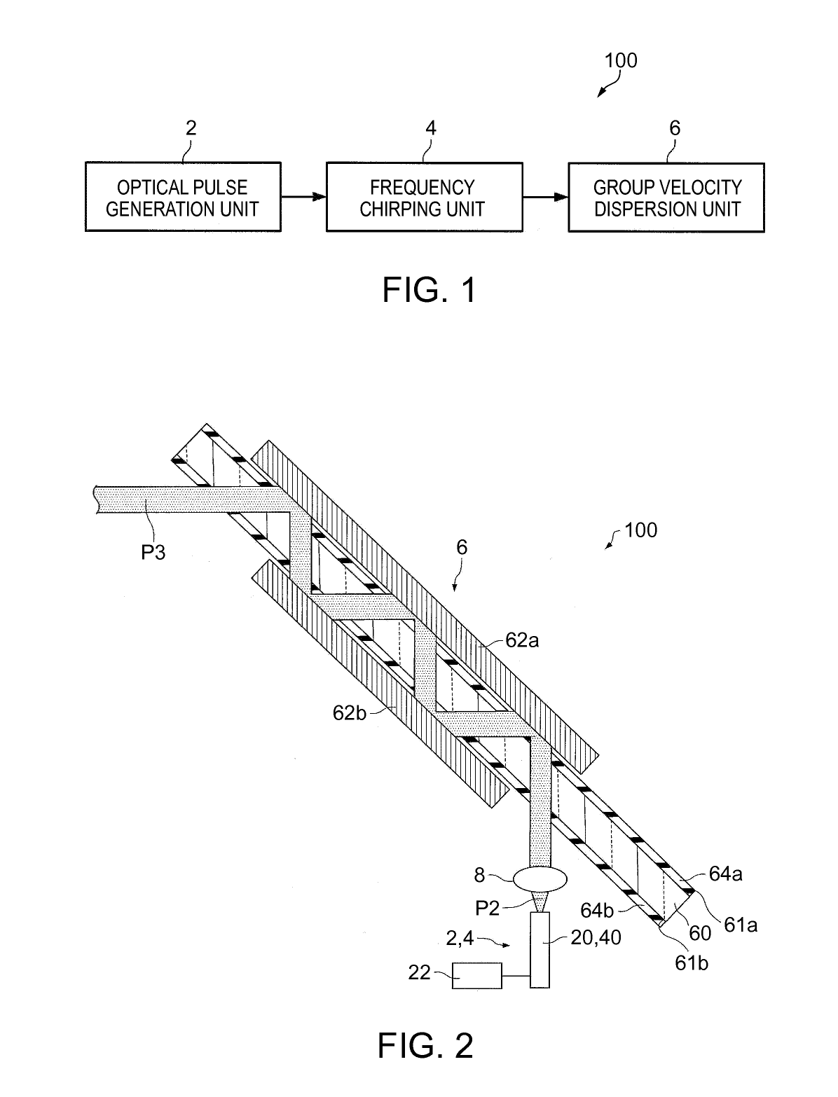

First, a short optical pulse generator 100 according to an embodiment will be described referring to the drawings. FIG. 1 is a functional block diagram of the short optical pulse generator 100 according to the embodiment.

As shown in FIG. 1, the short optical pulse generator 100 includes an optical pulse generation unit 2, a frequency chirping unit 4, and a group velocity dispersion unit 6.

The optical pulse generation unit 2 generates an optical pulse. Here, the optical pulse refers to light whose intensity changes steeply in a short time. The pulse width (full width at half maximum FWHM) of the optical pulse generated by the optical pulse generation unit 2 is not particularly limited, and is, for example, equal to or greater than 1 ps (picosecond) and equal to or less than 100 ps. The optical pulse generation unit 2 is, for example, a semiconductor laser, a super luminescent diode (SLD), or the like.

The frequency chirping unit 4 chirps the frequency of the optical pulse generated by the optical pulse generation unit 2. Here, chirping the frequency of the optical pulse refers to temporally changing the frequency of the optical pulse. The frequency chirping unit 4 is made of, for example, a semiconductor material and has a quantum well structure. The frequency chirping unit 4 is, for example, an optical waveguide which includes a layer having a quantum well structure. If the optical pulse propagates through the optical waveguide, the refractive index of the optical waveguide material is changed by an optical Kerr effect, and the phase of an electric field is changed (self phase modulation effect). The frequency of the optical pulse is chirped by the self phase modulation effect.

The frequency chirping unit 4 is made of a semiconductor material, and is thus low in response speed with respect to an optical pulse having a pulse width of about 1 ps to 100 ps. For this reason, in the frequency chirping unit 4, the frequency of the optical pulse is chirped (up-chirped or down-chirped) in proportion to the intensity (the square of electric field amplitude) of the optical pulse. Here, the up-chirp refers to a case where the frequency of the optical pulse increases with time, and the down-chirp refers to a case where the frequency of the optical pulse decreases with time. In other words, the up-chirp refers to a case where the wavelength of the optical pulse is shortened with time, and the down-chirp refers to a case where the wavelength of the optical pulse is lengthened with time.

The group velocity dispersion unit 6 produces a group velocity difference according to wavelength (frequency) in the optical pulse subjected to frequency chirp by the frequency chirping unit 4. Specifically, the group velocity dispersion unit 6 can produce a group velocity difference to make the pulse width of the optical pulse small for the optical pulse subjected to frequency chirp (pulse compression). For example, the group velocity dispersion unit 6 produces a positive group velocity dispersion in a down-chirped optical pulse, thereby making the pulse width small. In this case, the group velocity dispersion unit 6 is a normal dispersion medium. In this case, the group velocity dispersion unit 6 performs pulse compression based on group velocity dispersion. It should be noted that group velocity dispersion refers to the phenomenon in which the propagation velocity of the optical pulse differs according to wavelength, and thus, the group velocity changes depending on frequency. The positive group velocity dispersion refers to the phenomenon in which the group velocity increases with an increase in wavelength. In other words, the positive group velocity dispersion refers to the phenomenon in which the group velocity increases with a decrease in frequency. The pulse width of the optical pulse compressed by the group velocity dispersion unit 6 is not particularly limited, and is, for example, equal to or greater than 1 fs (femtosecond) and equal to or less than 800 fs.

Next, the specific structure of the short optical pulse generator 100 will be described referring to the drawings. FIG. 2 is a diagram schematically showing the short optical pulse generator 100.

As shown in FIG. 2, the optical pulse generation unit 2 includes a light emitting element 20. The frequency chirping unit 4 includes an optical waveguide 40. The group velocity dispersion unit 6 includes a group velocity dispersion medium 60, reflection mirrors 62a and 62b, and antireflection films 64a and 64b. The short optical pulse generator 100 includes a collimator lens 8.

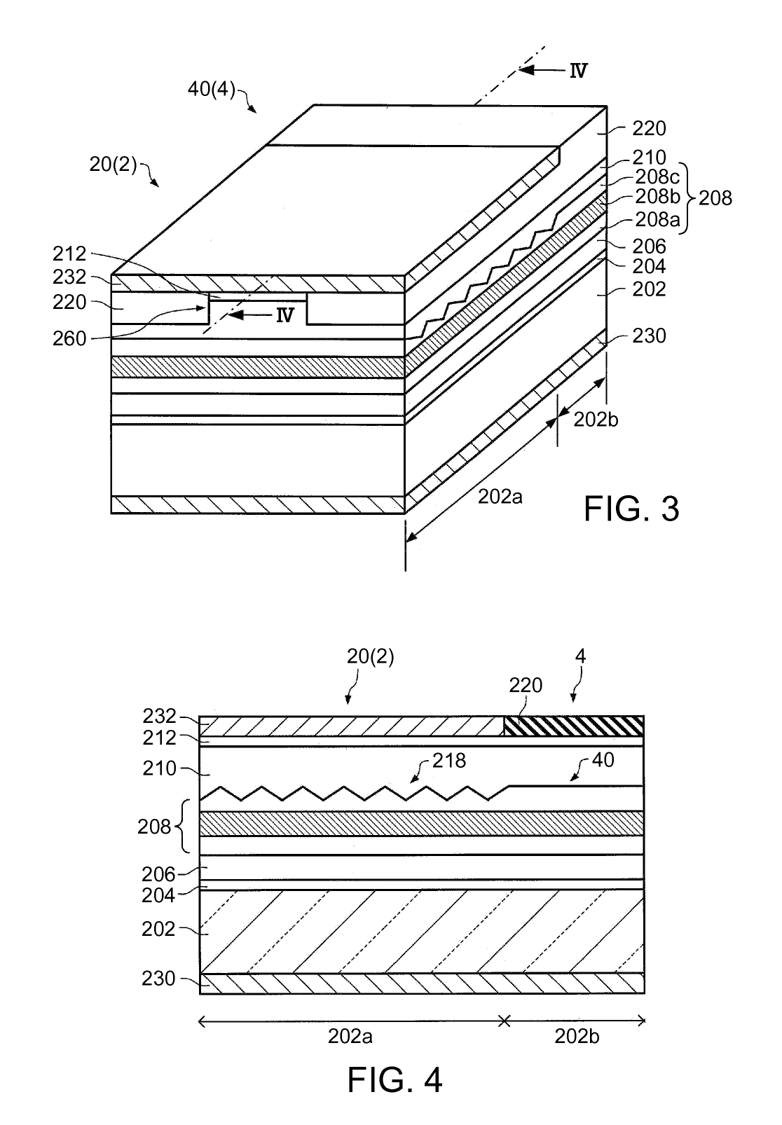

First, the light emitting element 20 constituting the optical pulse generation unit 2 and the optical waveguide 40 constituting the frequency chirping unit 4 will be described. FIG. 3 is a perspective view schematically showing the light emitting element 20 constituting the optical pulse generation unit 2 and the optical waveguide 40 constituting the frequency chirping unit 4. FIG. 4 is a sectional view schematically showing the light emitting element 20 and the optical waveguide 40. It should be noted that FIG. 4 is a sectional view taken along the line IV-IV of FIG. 3.

As shown in FIGS. 3 and 4, the light emitting element 20 and the optical waveguide 40 are provided integrally. That is, the light emitting element 20 and the optical waveguide 40 are provided on the same substrate 202.

The light emitting element 20 includes a substrate 202, a buffer layer 204, a first clad layer 206, a core layer 208, a second clad layer 210, a cap layer 212, an insulating layer 220, a first electrode 230, and a second electrode 232. Here, description will be provided as to an example where the light emitting element 20 is a distributed feedback (DFB) laser.

The optical waveguide 40 includes the first clad layer 206, the core layer 208, and the second clad layer 210.

The substrate 202 is, for example, a first conduction type (for example, n-type) GaAs substrate. The substrate 202 has a first region 202a where the light emitting element 20 is formed, and a second region 202b where the optical waveguide 40 is formed.

The buffer layer 204 is provided on the substrate 202. The buffer layer 204 is, for example, an n-type GaAs layer. The buffer layer 204 can improve crystallinity of an overlying layer.

The first clad layer 206 is provided on the buffer layer 204. The first clad layer 206 is, for example, an n-type AlGaAs layer.

The core layer 208 has a first guide layer 208a, an MQW layer 208b, and a second guide layer 208c.

The first guide layer 208a is provided on the first clad layer 206. The first guide layer 208a is, for example, an i-type AlGaAs layer.

The MQW layer 208b is provided on the first guide layer 208a. The MQW layer 208b has, for example, a multiquantum well structure in which a quantum well structure having a GaAs well layer and an AlGaAs barrier layer is stacked in three layers. Here, the quantum well structure indicates a general quantum well structure in the field of a semiconductor light emitting device, and is a structure in which a thin film (nm order) made of a material having a small band gap is sandwiched between thin films made of a material having a large band gap using two or more materials having different band gaps. In the example shown in the drawing, the number of quantum wells (the number of laminated GaAs well layers and AlGaAs barrier layers) of the MQW layer 208b is identical above the first region 202a and the second region 202b. That is, in the light emitting element 20 and the optical waveguide 40, the number of quantum wells of the MQW layer 208b is identical.

It should be noted that the number of quantum wells of the MQW layer 208b above the first region 202a and the number of quantum wells of the MQW layer 208b above the second region 202b may be different. That is, the number of quantum wells of the MQW layer 208b constituting the light emitting element 20 and the number of quantum wells of the MQW layer 208b constituting the optical waveguide 40 may be different.

The second guide layer 208c is provided on the MQW layer 208b. The second guide layer 208c is, for example, an i-type AlGaAs layer. The second guide layer 208c is provided with a periodic structure constituting a DFB resonator. The periodic structure is provided above the first region 202a. The periodic structure is constituted by two layers 208c and 210 having different refractive indexes.

The core layer 208 through which light generated in the MQW layer 208b propagates can be constituted by the first guide layer 208a, the MQW layer 208b, and the second guide layer 208c. The first guide layer 208a and the second guide layer 208c are layers which confine light in the core layer 208 at the same time as injection carriers (electron and hole) are confined in the MQW layer 208b.

The second clad layer 210 is provided on the core layer 208. The second clad layer 210 is, for example, a second conduction type (for example, p-type) AlGaAs layer. In the example shown in the drawing, the optical waveguides 218 and 40 are formed by the first clad layer 206, the core layer 208, and the second clad layer 210.

In the light emitting element 20, for example, a pin diode is constituted by the p-type second clad layer 210, the non-impurity-doped core layer 208, and the n-type first clad layer 206. Each of the first clad layer 206 and the second clad layer 210 is a layer which has a larger band gap and a smaller refractive index than the core layer 208. The core layer 208 has a function of generating light and guiding light while amplifying light. The first clad layer 206 and the second clad layer 210 have a function of confining injection carriers (electron and hole) and light with the core layer 208 sandwiched therebetween (a function of suppressing leakage of light).

In the light emitting element 20, if a forward bias voltage of the pin diode is applied between the first electrode 230 and the second electrode 232, an electron and a hole are recombined in the core layer 208 (MQW layer 208b). The recombination causes light emission. Induced emission is generated in chains starting with the emitted light, and intensity of light is amplified in the optical waveguide (gain region) 218.

The cap layer 212 is provided on the second clad layer 210. The cap layer 212 can be in ohmic contact with the second electrode 232. The cap layer 212 is, for example, a p-type GaAs layer.

The cap layer 212 and a part of the second clad layer 210 constitute a columnar portion 260. For example, in the light emitting element 20, a current path between the electrodes 230 and 232 is determined by a planar shape when viewed from the lamination direction of the respective layers of the columnar portion 260.

As shown in FIG. 3, the insulating layer 220 is provided lateral to the columnar portion 260 on the second clad layer 210. The insulating layer 220 is provided on the cap layer 212 above the second region 202b of the substrate 202. The insulating layer 220 is, for example, a SiN layer, a SiO₂ layer, a SiON layer, an Al₂O₃ layer, a polyimide layer, or the like.

When the above-described material is used as the insulating layer 220, a current between the electrodes 230 and 232 can avoid the insulating layer 220 and flow along the columnar portion 260 sandwiched by the insulating layer 220. The insulating layer 220 can have a refractive index smaller than the refractive index of the second clad layer 210. In this case, an effective refractive index of a vertical cross-section of a portion in which the insulating layer 220 is formed becomes smaller than an effective refractive index of a vertical cross-section of a portion in which the insulating layer 220 is not formed, that is, a portion in which the columnar portion 260 is formed. With this, it is possible to confine light in the optical waveguides 218 and 40 in the plane direction efficiently. Though not shown, it should be noted that an air layer may be provided as the insulating layer 220, instead of using the above-described material. In this case, the air layer can function as the insulating layer 220.

The first electrode 230 is provided on the entire lower surface of the substrate 202. The first electrode 230 is in contact with a layer (in the example shown in the drawing, the substrate 202) which is in ohmic contact with the first electrode 230. The first electrode 230 is electrically connected to the first clad layer 206 through the substrate 202. The first electrode 230 is one electrode for driving the light emitting element 20. As the first electrode 230, for example, an electrode in which a Cr layer, an AuGe layer, a Ni layer, and an Au layer are laminated in this order from the substrate 202 side, or the like maybe used. It should be noted that the first electrode 230 may be provided only below the first region 202a of the substrate 202.

The second electrode 232 is provided above the first region 202a on the upper surface of the cap layer 212. The second electrode 232 may be provided on the insulating layer 220. The second electrode 232 is electrically connected to the second clad layer 210 through the cap layer 212. The second electrode 232 is the other electrode for driving the light emitting element 20. As the second electrode 232, for example, an electrode in which a Cr layer, an AuZn layer, and an Au layer are laminated in this order from the cap layer 212 side, or the like may be used. It should be noted that, in the example shown in the drawing, although a double-sided electrode structure is made in which the first electrode 230 is provided on the lower surface of the substrate 202 and the second electrode 232 is provided on the upper surface of the substrate 202, a single-sided electrode structure may be made in which the first electrode 230 and the second electrode 232 are provided on the same surface (for example, the upper surface) of the substrate 202.

The buffer layer 204, the first clad layer 206, the core layer 208, the second clad layer 210, and the cap layer 212 are provided over the first region 202a and the second region 202b of the substrate 202. That is, these layers 204, 206, 208, 210, and 212 are layers common to the light emitting element 20 and the optical waveguide 40 and are continuous layers. The first clad layer 206, the core layer 208, and the second clad layer 210 which are continuous in the first region 202a and the second region 202b constitute the optical waveguide 218 and the optical waveguide 40. The optical waveguide 218 is provided above the first region 202a, and the optical waveguide 40 is provided above the second region 202b.

Although a case where an AlGaAs-based semiconductor material is used as an example of the light emitting element and the optical waveguide 40 has been described, the invention is not limited thereto, and for example, other semiconductor materials, such as AlGaN-based, GaN-based, InGaN-based, GaAs-based, InGaAs-based, InGaAsP-based, and ZnCdSe-based, may be used.

Although an example where the light emitting element 20 is a DFB laser has been described, the invention is not limited thereto, and a semiconductor laser, such as a DBR laser or a mode synchronous laser, may be used. The light emitting element 20 may be a super luminescent diode (SLD).

Though not shown, an electrode for applying a reverse bias to the optical waveguide 40 may be provided. With this, it is possible to control the absorption characteristic of the optical waveguide 40 and to adjust the chirp quantity of the frequency.

Here, although a case where the light emitting element 20 and the optical waveguide 40 are provided on the same substrate has been described, the light emitting element 20 and the optical waveguide 40 may be provided on separate substrates.

As shown in FIG. 2, the optical pulse generation unit 2 includes a drive circuit 22. The drive circuit 22 drives the light emitting element 20 by direct modulation. Here, the direct modulation refers to the use of a modulation signal for a drive current for generating the optical pulse in the light emitting element 20. In the optical pulse generation unit 2, the light emitting element 20 is driven by the drive circuit 22, whereby the optical pulse is generated.

Next, the group velocity dispersion medium 60, the reflection mirrors 62a and 62b, and the antireflection films 64a and 64b constituting the group velocity dispersion unit 6 will be described referring to FIG. 2.

The optical pulse chirped in the frequency chirping unit 4 is incident on the group velocity dispersion medium 60. The group velocity dispersion medium 60 is, for example, a glass substrate, a GaN substrate, a SiC substrate, a plastic substrate, or a sapphire substrate. For this reason, the group velocity dispersion medium 60 has a positive group velocity dispersion characteristic. Accordingly, in the group velocity dispersion medium 60, a positive group velocity dispersion is generated in the down-chirped optical pulse, thereby reducing the pulse width. It is preferable that the material of the group velocity dispersion medium 60 is a material with little absorption of the optical pulse.

In the example shown in the drawing, the group velocity dispersion medium 60 has a first surface 61a, and a second surface 61b opposite to the first surface 61a. The first surface 61a and the second surface 61b are the surfaces through which the optical pulse is incident and the optical pulse is emitted in the group velocity dispersion medium 60. The thickness of the group velocity dispersion medium 60 (the distance between the first surface 61a and the second surface 61b) is, for example, equal to or greater than 100 μm and equal to or less than 20 mm.

The reflection mirrors 62a and 62b are provided with the group velocity dispersion medium 60 sandwiched therebetween. The first reflection mirror 62a is provided to face the first surface 61a of the group velocity dispersion medium 60. A clearance is provided between the first reflection mirror 62a and the first surface 61a. The second reflection mirror 62b is provided to face the second surface 61b of the group velocity dispersion medium 60. A clearance is provided between the second reflection mirror 62b and the second surface 61b. The two reflection mirrors 62a and 62b are arranged to face each other with the group velocity dispersion medium 60 sandwiched therebetween. That is, the two reflection mirrors 62a and 62b face each other with the group velocity dispersion medium 60 sandwiched therebetween. In the example shown in the drawing, the two reflection mirrors 62a and 62b are arranged in parallel. The optical pulse is obliquely incident on the reflection mirrors 62a and 62b.

The reflection mirrors 62a and 62b are, for example, metal plates having a mirror-finished surface. As the reflection mirrors 62a and 62b, for example, a metal mirror, a dielectric multilayer mirror, or the like may be used.

The optical pulse incident on the group velocity dispersion medium 60 is reflected by the two reflection mirrors 62a and 62b multiple times and travels in the group velocity dispersion medium 60. In the example shown in the drawing, the optical pulse incident on the second surface 61b of the group velocity dispersion medium 60 propagates through the group velocity dispersion medium 60 and is emitted from the first surface 61a to the outside. The optical pulse emitted from the first surface 61a to the outside is reflected by the first reflection mirror 62a and is incident on the first surface 61a again. Then, the optical pulse incident on the first surface 61a propagates through the group velocity dispersion medium 60 and is emitted from the second surface 61b to the outside. The optical pulse emitted from the second surface 61b to the outside is reflected by the second reflection mirror 62b and is incident on the second surface 61b again. This is repeated, whereby the optical pulse travels in the group velocity dispersion medium 60. It should be noted that the number of reflections of the optical pulse in the reflection mirrors 62a and 62b is not particularly limited.

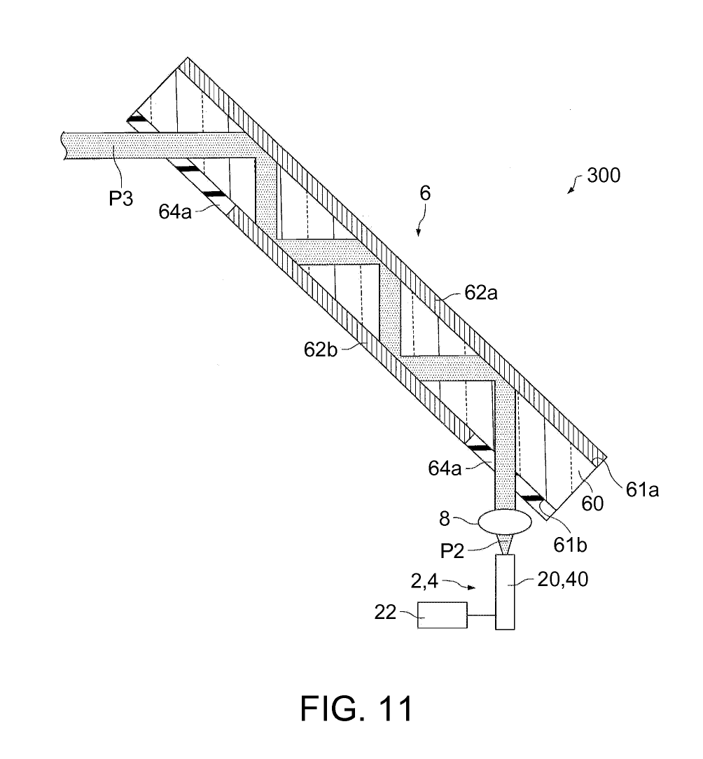

Here, the optical pulse traveling in the group velocity dispersion medium 60 includes a case where the optical pulse constantly travels in the group velocity dispersion medium 60 (see FIG. 11) and a case where, as shown in FIG. 2, the optical pulse travels while being repeatedly emitted from the group velocity dispersion medium 60 to the outside (atmosphere) and incident on the group velocity dispersion medium 60 from the outside again.

The group velocity dispersion unit 6 can obtain a group velocity dispersion value according to the distance of the optical pulse passing through the group velocity dispersion medium 60. That is, in the group velocity dispersion unit 6, when the distance of the optical pulse passing through the group velocity dispersion medium 60 is long, it is possible to generate a large group velocity difference in the optical pulse. Accordingly, in the group velocity dispersion unit 6, the number of reflections of the optical pulse by the two reflection mirrors 62a and 62b increases, thereby generating a large group velocity difference in the optical pulse.

It should be noted that, although a case where the group velocity dispersion unit 6 has the two reflection mirrors 62a and 62b has been described, the number of reflection mirrors is not particularly limited insofar as the number is equal to or greater than 2. For example, in addition to the reflection mirrors facing the first surface 61a and the second surface 61b of the group velocity dispersion medium 60, reflection mirrors may be provided to face other surfaces (for example, a surface connecting the first surface 61a and the second surface 61b, a lateral surface of the group velocity dispersion medium 60) of the group velocity dispersion medium 60. For example, a reflection mirror may be provided on all surfaces of the group velocity dispersion medium 60 (excluding the region where the optical pulse is incident and the region where the optical pulse is emitted).

The first antireflection film 64a is provided on the first surface 61a of the group velocity dispersion medium 60. The first antireflection film 64a is, for example, a SiO₂ layer, a Ta₂O₅ layer, an Al₂O₃ layer, a TiN layer, a TiO₂ layer, a SiON layer, a SiN layer, or a multilayer film thereof. The first antireflection film 64a can reduce the reflectance of the optical pulse on the first surface 61a.

The second antireflection film 64b is provided on the second surface 61b of the group velocity dispersion medium 60. The second antireflection film 64b is, for example, a SiO₂ layer, a Ta₂O₅ layer, an Al₂O₃ layer, a TiN layer, a TiO₂ layer, a SiON layer, a SiN layer, or a multilayer film thereof. The second antireflection film 64b can reduce the reflectance of the optical pulse on the second surface 61b.

The collimator lens 8 is provided on an optical path of the optical pulse between the optical waveguide 40 and the group velocity dispersion medium 60. The material of the collimator lens 8 is, for example, optical glass. The collimator lens 8 can convert the optical pulse emitted from the optical waveguide 40 and incident on the group velocity dispersion medium 60 to parallel light.

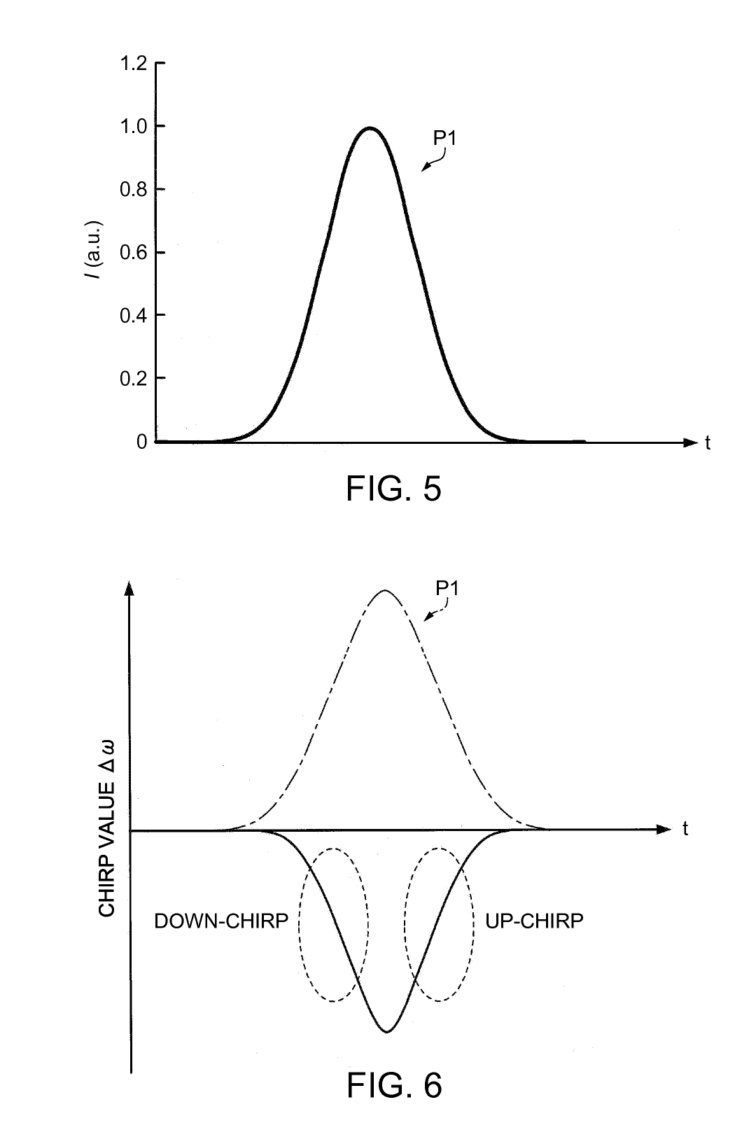

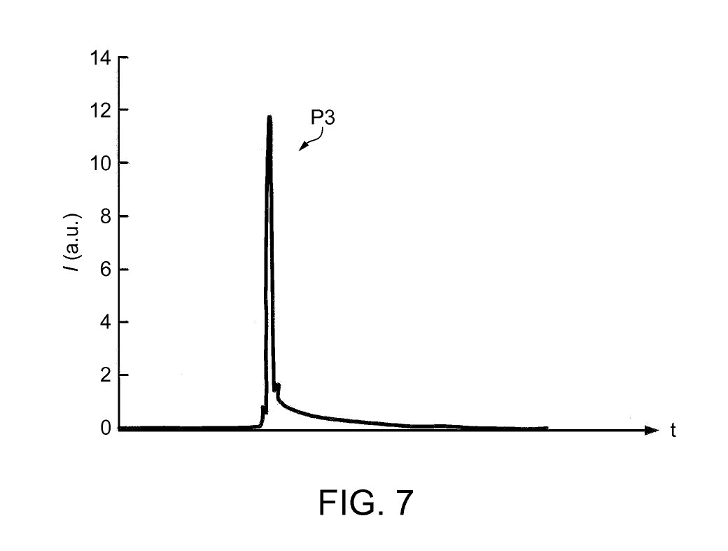

Next, the operation of the short optical pulse generator 100 will be described. FIG. 5 is a graph showing an example of an optical pulse P1 generated by the optical pulse generation unit 2. In the graph shown in FIG. 5, the horizontal axis t represents time and the vertical axis I represents light intensity. FIG. 6 is a graph showing an example of the chirp characteristic of the frequency chirping unit 4. In the graph shown in FIG. 6, the horizontal axis t represents time and the vertical axis Δω represents a chirp quantity (variation in frequency). It should be noted that, in FIG. 6, the optical pulse P1 is indicated by a one-dot-chain line and the chirp quantity Δω corresponding to the optical pulse P1 is indicated by a solid line. FIG. 7 is a graph showing an example of an optical pulse P3 generated by the group velocity dispersion unit 6. In the graph shown in FIG. 7, the horizontal axis t represents time and the vertical axis I represents light intensity.

For example, the optical pulse generation unit 2 generates the optical pulse P1 shown in FIG. 5. In the optical pulse generation unit 2, the forward bias voltage of the pin diode is applied between the first electrode 230 and the second electrode 232 shown in FIGS. 2 and 3, whereby the optical pulse P1 is generated. In the example shown in the drawing, the optical pulse P1 is a Gaussian waveform. In the example shown in the drawing, the pulse width (full width at half maximum FWHM) t of the optical pulse P1 is 10 ps (picosecond). The optical pulse P1 propagates through the optical waveguide 218 and is incident on the frequency chirping unit 4 (optical waveguide 40).

The frequency chirping unit 4 has the chirp characteristic proportional to light intensity. Expression (1) is an expression representing the effect of frequency chirp.

$$Δω = - \frac{{n}_{2} l {ω}_{0}}{2 c {τ}_{r}} {\vert E \vert}^{2} \qquad ( 1 )$$

It should be noted that Δω is a chirp quantity (variation in frequency), c is a light speed, τᵣ is a response time of a nonlinear refractive index effect, n₂ is a nonlinear refractive index, l is a waveguide length, ω₀ is a center frequency of an optical pulse, and E is amplitude of an electric field.

The frequency chirping unit 4 applies frequency chirp represented in Expression (1) to the optical pulse P1 propagating through the optical waveguide 40. Specifically, as shown in FIG. 6, the frequency chirping unit 4 decreases the frequency with time in the front portion of the optical pulse P1 and increases the frequency with time in the rear portion of the optical pulse P1. That is, the frequency chirping unit 4 down-chirps the front portion of the optical pulse P1 and up-chirps the rear portion of the optical pulse P1.

Accordingly, the optical pulse P1 generated by the optical pulse generation unit 2 passes through the frequency chirping unit 4 and thus becomes an optical pulse (hereinafter, referred to as “optical pulse P2”) in which the front portion is down-chirped and the rear portion is up-chirped. The chirped optical pulse P2 (not shown) is converted to parallel light by the collimator lens 8 and is incident on the group velocity dispersion unit 6 (group velocity dispersion medium 60).

The group velocity dispersion unit 6 produces a group velocity difference according to wavelength in the optical pulse P2 chirped by the frequency chirping unit 4. Specifically, the optical pulse P2 incident on the group velocity dispersion medium 60 is reflected by the two reflection mirrors 62a and 62b multiple times and travels in the group velocity dispersion medium 60. In this case, the group velocity dispersion medium 60 produces a positive group velocity dispersion in the optical pulse P2 traveling in the group velocity dispersion medium 60. With this, the front portion of the down-chirped optical pulse P2 is compressed, and an optical pulse P3 shown in FIG. 7 is generated. The optical pulse P3 compressed by the group velocity dispersion unit 6 is emitted from the group velocity dispersion medium 60.

For example, the short optical pulse generator 100 has the following feature.

The short optical pulse generator 100 includes the optical pulse generation unit 2 which generates the optical pulse, the frequency chirping unit 4 which chirps the frequency of the optical pulse, and the group velocity dispersion unit 6 which produces the group velocity difference according to wavelength in the optical pulse chirped by the frequency chirping unit 4. Accordingly, in the short optical pulse generator 100, for example, it is possible to increase the chirp quantity of the optical pulse and to sufficiently compress the pulse width in the group velocity dispersion unit 6 compared to a case where there is no frequency chirping unit 4. Therefore, the short optical pulse generator 100 can generate an optical pulse with a small pulse width.

In the short optical pulse generator 100, the frequency chirping unit 4 has the quantum well structure (MQW layer 208b), whereby it is possible to achieve reduction in size of the apparatus. Hereinafter, the reason will be described.

As represented in Expression (1) described above, the chirp quantity Δω is proportional to the nonlinear refractive index n₂. That is, when the nonlinear refractive index is large, the chirp quantity per unit length increases. Here, the nonlinear refractive index n₂ of a general quartz fiber (SiO₂ glass) is about 10⁻²⁰ m²/W. In contrast, the nonlinear refractive index n₂ of a semiconductor material having a quantum well structure is about 10⁻¹⁰ to 10⁻⁸ m²/W. In this way, the semiconductor material having the quantum well structure has the extremely large nonlinear refractive index n₂ compared to the quartz fiber. For this reason, when the semiconductor material having the quantum well structure is used as the frequency chirping unit 4, it is possible to increase the chirp quantity per unit length and to shorten the length of the optical waveguide for chirping the frequency compared to a case where the quartz fiber is used. Accordingly, it is possible to reduce the frequency chirping unit 4 in size and to achieve reduction in size of the apparatus.

In the short optical pulse generator 100, the group velocity dispersion unit 6 includes the group velocity dispersion medium 60 on which the optical pulse chirped by the frequency chirping unit 4 is incident, and the two reflection mirrors 62a and 62b which are provided with the group velocity dispersion medium 60 sandwiched therebetween. The optical pulse incident on the group velocity dispersion medium 60 is reflected by the two reflection mirrors 62a and 62b multiple times and travels in the group velocity dispersion medium 60. With this, it is possible to reduce the group velocity dispersion unit 6 in size, for example, compared to a case where the group velocity dispersion unit has no reflection mirrors 62a and 62b, that is, a case where the optical pulse travels in the group velocity dispersion medium 60 without using the reflection mirrors 62a and 62b. For example, even when a material having a small group velocity dispersion value per unit length is used as the group velocity dispersion medium 60, the number of reflections in the two reflection mirrors 62a and 62b increases, whereby it is possible to increase the group velocity dispersion value of the group velocity dispersion unit 6. In the short optical pulse generator 100, it is possible to realize the group velocity dispersion unit 6 with a simple configuration.

In the short optical pulse generator 100, the group velocity dispersion medium 60 is a glass substrate. Accordingly, it is possible to achieve reduction in cost of the apparatus. The glass substrate does not extremely absorb the optical pulse generated by the optical pulse generation unit 2. For this reason, in the short optical pulse generator 100, it is possible to suppress a decrease in intensity of the optical pulse in the group velocity dispersion medium 60.

In the short optical pulse generator 100, the antireflection films 64a and 64b are provided on the surface of the group velocity dispersion medium 60 on which the optical pulse P2 is incident and the surface of the group velocity dispersion medium 60 from which the optical pulse P2 is emitted. With this, it is possible to reduce the reflectance of the optical pulse on the surface of the group velocity dispersion medium 60 on which the optical pulse P2 is incident and the surface of the group velocity dispersion medium 60 from which the optical pulse P2 is emitted.

The short optical pulse generator 100 includes the collimator lens 8 which converts the optical pulse incident on the group velocity dispersion unit 6 to parallel light. For this reason, in the short optical pulse generator 100, it is possible to suppress the spread of the optical pulse incident on the group velocity dispersion medium 60.

### 2. MODIFICATION EXAMPLES

### 2.1. First Modification Example

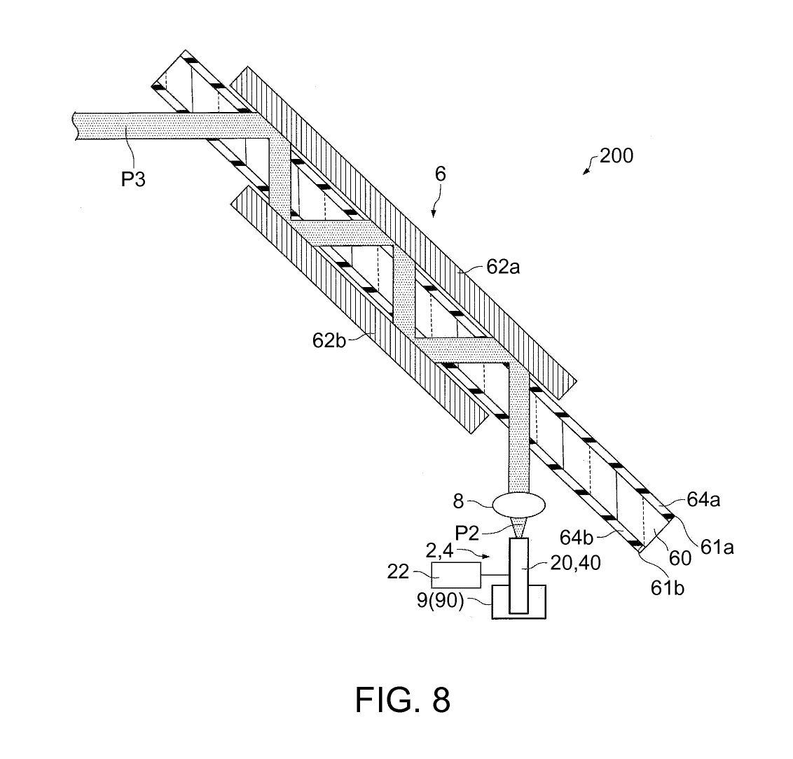

Next, a short optical pulse generator according to a first modification example of the embodiment will be described referring to the drawings. FIG. 8 is a diagram schematically showing a short optical pulse generator 200 according to the first modification example of the embodiment and corresponds to FIG. 2.

Hereinafter, in the short optical pulse generator 200 according to the first modification example of the embodiment, a difference from the example of the short optical pulse generator 100 according to the embodiment will be described, and description of the same points will not be repeated. The same applies to a short optical pulse generator according to a second modification example of the embodiment described below.

As shown in FIG. 8, the short optical pulse generator 200 is different from the above-described short optical pulse generator 100 in that a variable mechanism 9 which changes the incidence angle of the optical pulse P2 to the two reflection mirrors 62a and 62b is provided.

For example, the variable mechanism 9 has a stage 90 on which the light emitting element 20 and the optical waveguide 40 are placed, and a drive circuit (not shown) which drives (rotates) the stage 90. The stage 90 is rotatable based on a signal from the drive circuit. The rotation of the stage allows the light emitting element 20 and the optical waveguide 40 to rotate, whereby it is possible to change the incidence angle of the optical pulse to the two reflection mirrors 62a and 62b.

It should be noted that the variable mechanism 9 is not limited to a form in which the light emitting element 20 and the optical waveguide 40 are rotated, and a form may be made in which the two reflection mirrors 62a and 62b are rotated to change the incidence angle of the optical pulse to the two reflection mirrors 62a and 62b. The variable mechanism 9 may rotate an optical element (not shown), such as a mirror which changes the travel direction of the optical pulse incident on the two reflection mirrors 62a and 62b, thereby changing the incidence angle of the optical pulse to the two reflection mirrors 62a and 62b.

The operation of the short optical pulse generator 200 is the same as the operation of the above-described short optical pulse generator 100, except that the incidence angle of the optical pulse to the two reflection mirrors 62a and 62b can be changed, and description thereof will not be repeated.

As described above, the short optical pulse generator 200 includes the variable mechanism 9 which changes the incidence angle of the optical pulse to the two reflection mirrors 62a and 62b. With this, in the short optical pulse generator 200, it is possible to change the number of reflections of the optical pulse in the two reflection mirrors 62a and 62b. As a result, in the short optical pulse generator 200, it is possible to change the group velocity dispersion value of the group velocity dispersion unit 6 and to change the pulse width of the optical pulse generated by the short optical pulse generator 200.

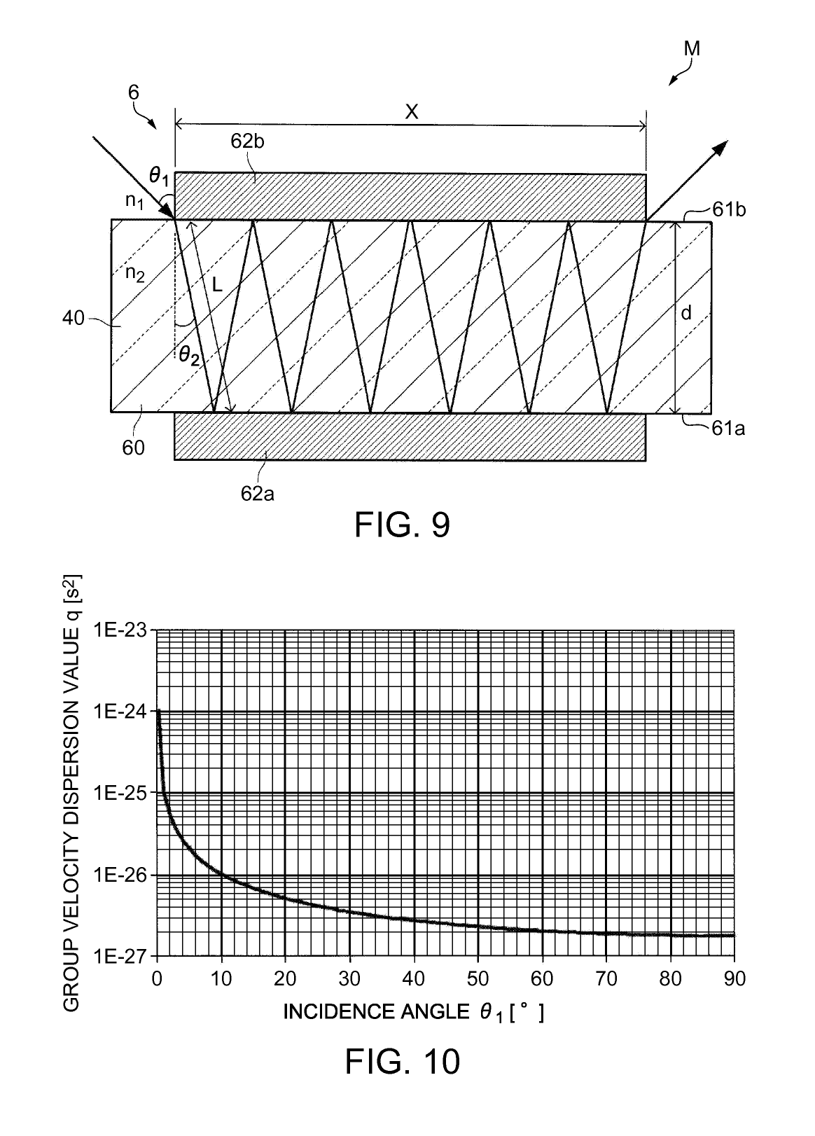

Hereinafter, the relationship between the incidence angle of the optical pulse to the two reflection mirrors 62a and 62b and the group velocity dispersion value of the group velocity dispersion unit 6 will be described. FIG. 9 is a diagram schematically showing a model M for describing the relationship between the incidence angle of the optical pulse to the two reflection mirrors 62a and 62b and the group velocity dispersion value of the group velocity dispersion unit 6.

In the model M, as shown in FIG. 9, the incidence angle of the optical pulse incident on the group velocity dispersion medium 60 is represented as θ₁. The refraction angle of the optical pulse on the second surface 61b of the group velocity dispersion medium 60 is represented as θ₂. The refractive index of a medium (for example, air) before the optical pulse is incident on the group velocity dispersion medium 60 is represented as n₁. The refractive index of the group velocity dispersion medium 60 is represented as n₂. The length of the group velocity dispersion medium 60 (the length of the reflection mirrors 62a and 62b) is represented as X. The thickness of the group velocity dispersion medium 60 is represented as d. When the optical pulse travels in the group velocity dispersion medium 60 while being reflected between the two reflection mirrors 62a and 62b, a moving distance when the optical pulse travels from one reflection mirror 62a to the other reflection mirror 62b is represented as L.

In the model M shown in FIG. 9, the number of reflections necessary for obtaining a desired group velocity dispersion value is calculated. First, Expression (2) is established by Snell's law.

n₁ sin θ₁=n₂ sin θ₂ (2)

If Expression (2) is used, the distance L is expressed as Expression (3).

$$L = \frac{d}{cos {θ}_{2}} = \frac{d}{\sqrt{1 - {sin}^{2} {θ}_{2}}} = \frac{d}{\sqrt{1 - {( \frac{{n}_{1}}{{n}_{2}} )}^{2} {sin}^{2} {θ}_{1}}} \qquad ( 3 )$$

If the group velocity dispersion value per unit length of the group velocity dispersion medium 60 is p, and the desired group velocity dispersion value is q, a distance necessary for obtaining the desired group velocity dispersion value q becomes q/p. Therefore, the required number of reflections RT_{g} is expressed as Expression (4).

$${RT}_{g} = \frac{q / p}{L} - 1 = \frac{q}{p} \frac{\sqrt{1 - {( \frac{{n}_{1}}{{n}_{2}} )}^{2} {sin}^{2} {θ}_{1}}}{d} - 1 \qquad ( 4 )$$

In this case, the length X of the group velocity dispersion medium 60 is expressed as Expression (5).

$$X = ( {RT}_{g} + 1 ) d tan {θ}_{2} = \frac{q}{p} \frac{{n}_{1}}{{n}_{2}} sin {θ}_{1} \qquad ( 5 )$$

If Expression (5) is modified, the group velocity dispersion value q obtained by the group velocity dispersion unit 6 is expressed as Expression (6).

$$q = \frac{{n}_{1}}{{n}_{2}} \frac{pX}{sin {θ}_{1}} \qquad ( 6 )$$

As will be understood from Expression (6), the thickness d of the group velocity dispersion medium 60 can be set as a parameter which does not affect the group velocity dispersion value q of the group velocity dispersion unit 6. Accordingly, when reflection loss in the reflection mirrors 62a and 62b is negligible, it is possible to make the thickness d of the group velocity dispersion medium 60 small and to reduce the short optical pulse generator 100 in size. When reflection loss is not negligible, the thickness d of the group velocity dispersion medium 60 increases, thereby reducing the number of reflections in the reflection mirrors 62a and 62b.

Here, it is assumed that the wavelength of the optical pulse incident on the group velocity dispersion medium 60 is 850 nm, the incidence angle θ₁ is 0.1°, the medium before the optical pulse is incident on the group velocity dispersion medium 60 is air (n₁=1), and the material of the group velocity dispersion medium 60 is glass (BK7), and the thickness d of the group velocity dispersion medium 60 is 10 mm. The refractive index n₂ of the group velocity dispersion medium 60 becomes 1.51 with respect to light of the wavelength 850 nm. The group velocity dispersion value per mm of the group velocity dispersion medium 60 becomes 4.7×10⁻²⁹ s²/mm with respect to light of the wavelength 850 nm. If the desired group velocity dispersion value q is 1×10⁻²⁴ s², the number of reflections RT_{g}≅2127 from Expression (4). The length X of the group velocity dispersion medium 60 X≅2.5 cm from Expression (5).

As described above, when the length X of the group velocity dispersion medium 60 is 2.5 cm, n₁ is 1, and n₂ is 1.51, and when the incidence angle θ₁ is changed, the relationship between the incidence angle θ₁ and the group velocity dispersion value q becomes the graph shown in FIG. 10 from Expression (6). From the graph shown in FIG. 10, it is understood that the incidence angle θ₁ is changed, whereby the group velocity dispersion value of the group velocity dispersion unit 6 is variable in a range of 1.77×10⁻²⁷ s² to 1×10⁻²⁴ s².

It should be noted that, in the short optical pulse generator 200 shown in FIG. 2, although the antireflection films 64a and 64b and the clearance are provided between the group velocity dispersion medium 60 and the reflection mirrors 62a and 62b, the distance of the optical pulse passing through the antireflection films 64a and 64b and the clearance is negligible.

### 2.2. Second Modification Example

Next, a short optical pulse generator according to a second modification example of the embodiment will be described referring to the drawings. FIG. 11 is a diagram schematically showing a short optical pulse generator 300 according to the second modification example of the embodiment and corresponds to FIG. 2.

As shown in FIG. 11, the short optical pulse generator 300 according to the second modification example is different from the short optical pulse generator 100 in that the first reflection mirror 62a is provided above the first surface 61a of the group velocity dispersion medium 60 and the second reflection mirror 62b is provided above the second surface 61b of the group velocity dispersion medium 60.

The reflection mirrors 62a and 62b are, for example, metal films. The reflection mirrors 62a and 62b may be dielectric multilayer film mirrors. For example, the reflection mirrors 62a and 62b are formed by forming films on the group velocity dispersion medium 60 by a sputtering method or a CVD method. On the second surface 61b of the group velocity dispersion medium 60, the region where the optical pulse P2 is incident and a region where the optical pulse P3 is emitted are provided with an antireflection film 64a without the reflection mirrors 62a and 62b.

The operation of the short optical pulse generator 300 is the same as the operation of the above-described short optical pulse generator 100, and description thereof will not be repeated.

The short optical pulse generator 300 can exhibit the same functional effects as the above-described short optical pulse generator 100.

### 3. TERAHERTZ WAVE GENERATOR

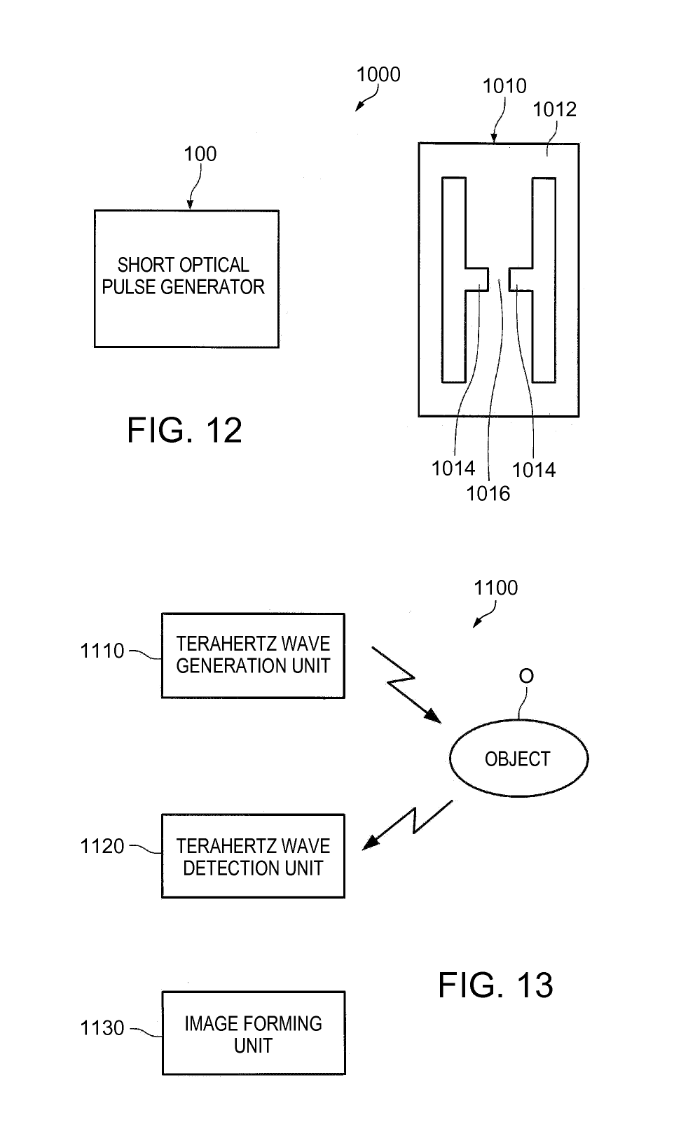

Next, a terahertz wave generator 1000 of the embodiment will be described referring to the drawings. FIG. 12 is a diagram showing the configuration of the terahertz wave generator 1000 according to the embodiment.

As shown in FIG. 12, the terahertz wave generator 1000 includes the short optical pulse generator according to the embodiment of the invention, and a photoconductive antenna 1010. Here, description will be provided as to a case where the short optical pulse generator 100 is used as the short optical pulse generator according to the embodiment of the invention.

The short optical pulse generator 100 generates a short optical pulse (for example, the optical pulse P3 shown in FIG. 7) which is excitation light. The pulse width of the short optical pulse generated by the short optical pulse generator 100 is, for example, equal to or greater than 1 fs and equal to or less than 800 fs.

The photoconductive antenna 1010 generates a terahertz wave when irradiated with the short optical pulse generated by the short optical pulse generator 100. It should be noted that the terahertz wave refers to an electromagnetic wave having a frequency equal to or greater than 100 GHz and equal to or less than 30 THz, and in particular, an electromagnetic wave having a frequency equal to or greater than 300 GHz and equal to or less than 3 THz.

In the example shown in the drawing, the photoconductive antenna 1010 is a dipole photoconductive antenna (PCA). The photoconductive antenna 1010 has a substrate 1012 which is a semiconductor substrate, and a pair of electrodes 1014 which are provided on the substrate 1012 and are arranged to face each other through a gap 1016. If the electrodes 1014 are irradiated with the optical pulse, the photoconductive antenna 1010 generates the terahertz wave.

The substrate 1012 has, for example, a semi-insulating GaAs (SI-GaAs) substrate, and a low-temperature growth GaAs (LT-GaAs) layer which is provided on the SI-GaAs substrate. The material for the electrodes 1014 is, for example, Au. The distance between a pair of electrodes 1014 is not particularly limited and is appropriately set according to a condition. The distance between a pair of electrodes 1014 is, for example, equal to or greater than 1 μm and equal to or less than 10 μm.

In the terahertz wave generator 1000, first, the short optical pulse generator 100 generates the short optical pulse and emits the short optical pulse toward the gap 1016 of the photoconductive antenna 1010. The gap 1016 of the photoconductive antenna 1010 is irradiated with the short optical pulse emitted from the short optical pulse generator 100. In the photoconductive antenna 1010, the gap 1016 is irradiated with the short optical pulse, whereby a free electron is excited. Then, the free electron is accelerated by applying a voltage between the electrodes 1014. With this, the terahertz wave is generated.

### 4. IMAGING APPARATUS

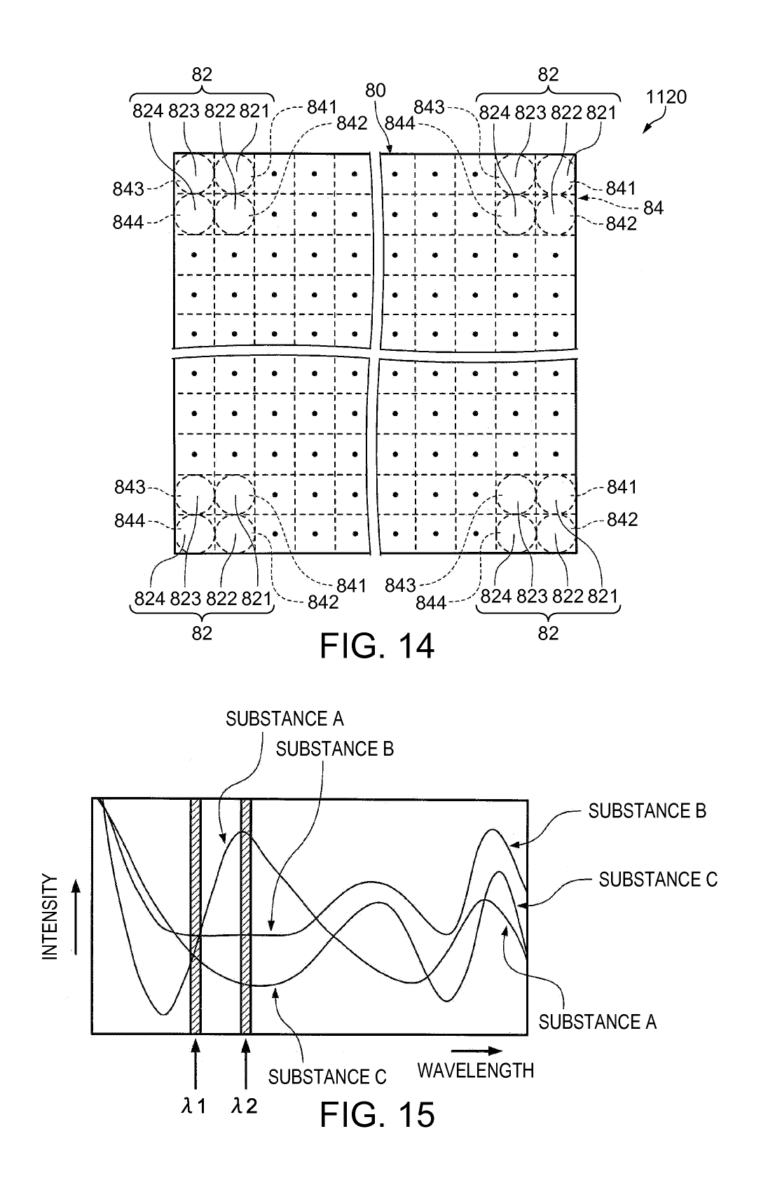

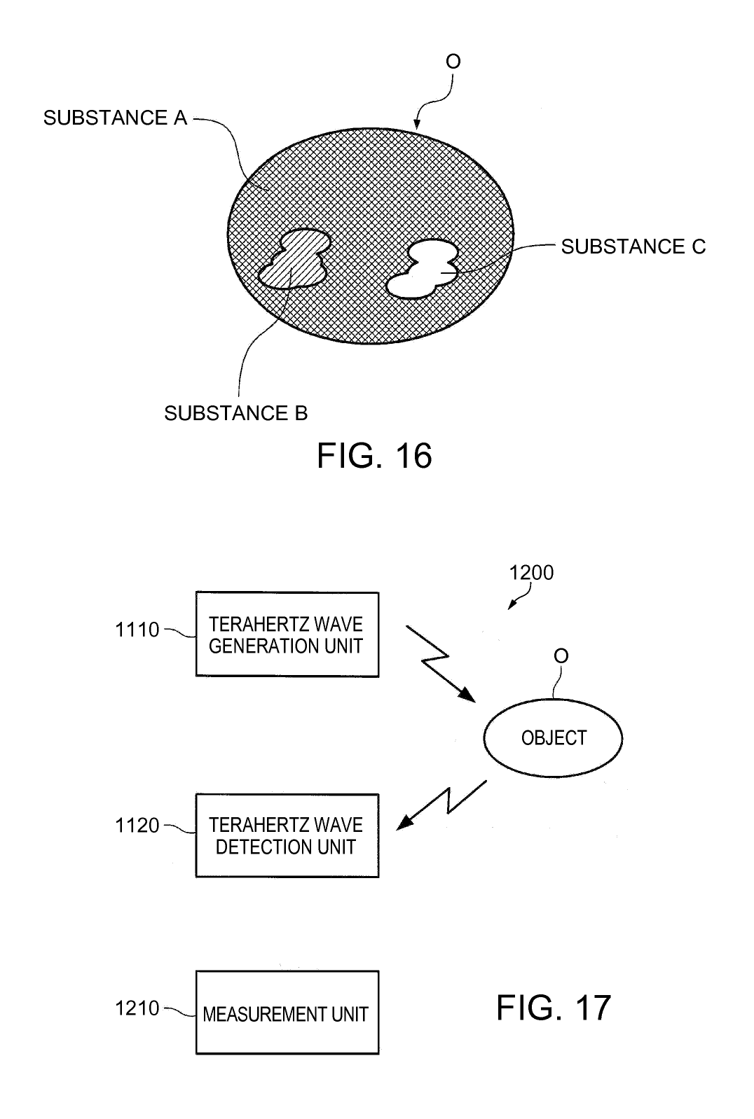

Next, an imaging apparatus 1100 according to the embodiment will be described referring to the drawings. FIG. 13 is a block diagram showing the imaging apparatus 1100 according to the embodiment. FIG. 14 is a plan view schematically showing a terahertz wave detection unit 1120 of the imaging apparatus 1100 according to the embodiment. FIG. 15 is a graph showing a spectrum in a terahertz band of an object. FIG. 16 is a diagram of an image representing the distribution of substances A, B, and C of the object.

As shown in FIG. 13, the imaging apparatus 1100 includes a terahertz wave generation unit 1110 which generates a terahertz wave, a terahertz wave detection unit 1120 which detects the terahertz wave emitted from the terahertz wave generation unit 1110 and transmitted through an object O or the terahertz wave reflected by the object O, and an image forming unit 1130 which generates the image of the object O, that is, image data, based on the detection result of the terahertz wave detection unit 1120.

As the terahertz wave generation unit 1110, the terahertz wave generator according to the embodiment of the invention can be used. Here, description will be provided as to a case where the terahertz wave generator 1000 is used as the terahertz wave generator according to the embodiment of the invention.

As the terahertz wave detection unit 1120, as shown in FIG. 14, a terahertz wave detection unit including a filter 80 which transmits a terahertz wave having a target wavelength, and a detection unit 84 which detects the terahertz wave having the target wavelength transmitted through the filter 80 is used. As the detection unit 84, for example, a detection unit which converts the terahertz wave to heat and detects heat, that is, a detection unit which converts the terahertz wave to heat and can detect the energy (intensity) of the terahertz wave is used. As the detection unit, for example, a piezoelectric sensor, a bolometer, or the like is used. It should be noted that the configuration of the terahertz wave detection unit 1120 is not limited to the above-described configuration.

The filter 80 has a plurality of pixels (unit filter unit) 82 arranged in a two-dimensional manner. That is, the pixels 82 are arranged in a matrix.

Each pixel 82 has a plurality of regions which transmit terahertz waves having different wavelengths, that is, a plurality of regions in which the wavelengths (hereinafter, also referred to as “transmitting wavelengths) of transmitting terahertz waves are different from one another. It should be noted that, in the configuration shown in the drawing, each pixel 82 has a first region 821, a second region 822, a third region 823, and a fourth region 824.

The detection unit 84 has a first unit detection unit 841, a second unit detection unit 842, a third unit detection unit 843, and a fourth unit detection unit 844 which are provided respectively corresponding to the first region 821, the second region 822, the third region 823, and the fourth region 824 of each pixel 82 of the filter 80. Each first unit detection unit 841, each second unit detection unit 842, each third unit detection unit 843, and each fourth unit detection unit 844 respectively convert the terahertz waves transmitted through the first region 821, the second region 822, the third region 823, and the fourth region 824 of each pixel 82 to heat and detect heat. With this, it is possible to reliably detect terahertz waves having four target wavelengths for each pixel 82.

Next, a use example of the imaging apparatus 1100 will be described.

First, it is assumed that an object O which is subjected to spectroscopic imaging has three substances A, B, and C. The imaging apparatus 1100 performs spectroscopic imaging of the object O. Here, as an example, it is assumed that the terahertz wave detection unit 1120 detects the terahertz wave reflected by the object O.

In each pixel 82 of the filter 80 of the terahertz wave detection unit 1120, the first region 821 and the second region 822 are used. When the transmitting wavelength of the first region 821 is λ1, the transmitting wavelength of the second region 822 is λ2, the intensity of a component of the wavelength λ1 of the terahertz wave reflected by the object O is α1, and the intensity of a component of the wavelength λ2 of the terahertz wave reflected by the object O is α2, the transmitting wavelength λ1 of the first region 821 and the transmitting wavelength λ2 of the second region 822 are set such that the difference (α2−α1) between the intensity α2 and the intensity α1 can be distinctively distinguished among the substance A, the substance B, and the substance C.

As shown in FIG. 15, in the substance A, the difference (α2−α1) between the intensity α2 of the component of the wavelength λ2 and the intensity al of the component of the wavelength λ1 of the terahertz wave reflected by the object O has a positive value. In the substance B, the difference (α2−α1) between the intensity α2 and the intensity α1 becomes zero. In the substance C, the difference (α2−α1) between the intensity α2 and the intensity α1 has a negative value.

When performing spectroscopic imaging of the object O by the imaging apparatus 1100, first, the terahertz wave is generated by the terahertz wave generation unit 1110, and the object O is irradiated with the terahertz wave. Then, the terahertz wave reflected by the object O is detected by the terahertz wave detection unit 1120 as α1 and α2. The detection result is transmitted to the image forming unit 1130. It should be noted that the irradiation of the object O with the terahertz wave and the detection of the terahertz wave reflected by the object O are performed for the entire object O.

The image forming unit 1130 obtains the difference (α2−α1) between the intensity α2 of a component of the wavelength λ2 of the terahertz wave transmitted through the second region 822 of the filter 80 and the intensity α1 of a component of the wavelength λ1 of the terahertz wave transmitted through the first region 821 based on the detection result. Then, a region of the object O where the difference has a positive value, a region where the difference becomes zero, and a region where the difference has a negative value are determined to be respectively the substance A, the substance B, and the substance C and specified.

In the image forming unit 1130, as shown in FIG. 16, image data of an image representing the distribution of the substances A, B, and C of the object O is created. Image data is transmitted from the image forming unit 1130 to a monitor (not shown), and the image representing the distribution of the substances A, B, and C of the object O is displayed on the monitor. In this case, for example, a region of the object O where the substance A is distributed, a region where the substance B is distributed, and a region where the substance C is distributed are respectively displayed black, gray, and white in a color-coded manner. In the imaging apparatus 1100, as described above, it is possible to simultaneously perform the identification of each substance constituting the object O and the distribution measurement of each substance.

The purpose of the imaging apparatus 1100 is not limited to the above-described purpose, and for example, a person maybe irradiated with the terahertz wave, the terahertz wave transmitted through or reflected by the person may be detected, and processing may be performed in the image forming unit 1130, thereby performing determination about whether or not the person carries a gun, a knife, an illegal drug, or the like.

### 5. MEASUREMENT APPARATUS

Next, a measurement apparatus 1200 according to the embodiment will be described referring to the drawings. FIG. 17 is a block diagram showing the measurement apparatus 1200 according to the embodiment. In the measurement apparatus 1200 according to the embodiment described below, the members having the same functions as the component members of the above-described imaging apparatus 1100 are represented by the same reference numerals, and detailed description thereof will not be repeated.

As shown in FIG. 17, the measurement apparatus 1200 includes a terahertz wave generation unit 1110 which generates a terahertz wave, a terahertz wave detection unit 1120 which detects the terahertz wave emitted from the terahertz wave generation unit 1110 and transmitted through an object O or the terahertz wave reflected by the object O, and a measurement unit 1210 which measures the object O based on the detection result of the terahertz wave detection unit 1120.

Next, a use example of the measurement apparatus 1200 will be described. When performing spectroscopic measurement of the object O by the measurement apparatus 1200, first, the terahertz wave is generated by the terahertz wave generation unit 1110, and the object O is irradiated with the terahertz wave. Then, the terahertz wave transmitted through the object O or the terahertz wave reflected by the object O is detected by the terahertz wave detection unit 1120. The detection result is transmitted to the measurement unit 1210. It should be noted that the irradiation of the object O with the terahertz wave and the detection of the terahertz wave transmitted through the object O or the terahertz wave reflected by the object O are performed for the entire object O.

The measurement unit 1210 understands the intensities of the terahertz waves transmitted through the first region 821, the second region 822, the third region 823, and the fourth region 824 of each pixel 82 of the filter 80 from the detection result, and analyzes the components of the object O, the distribution of the components, or the like.

### 6. CAMERA

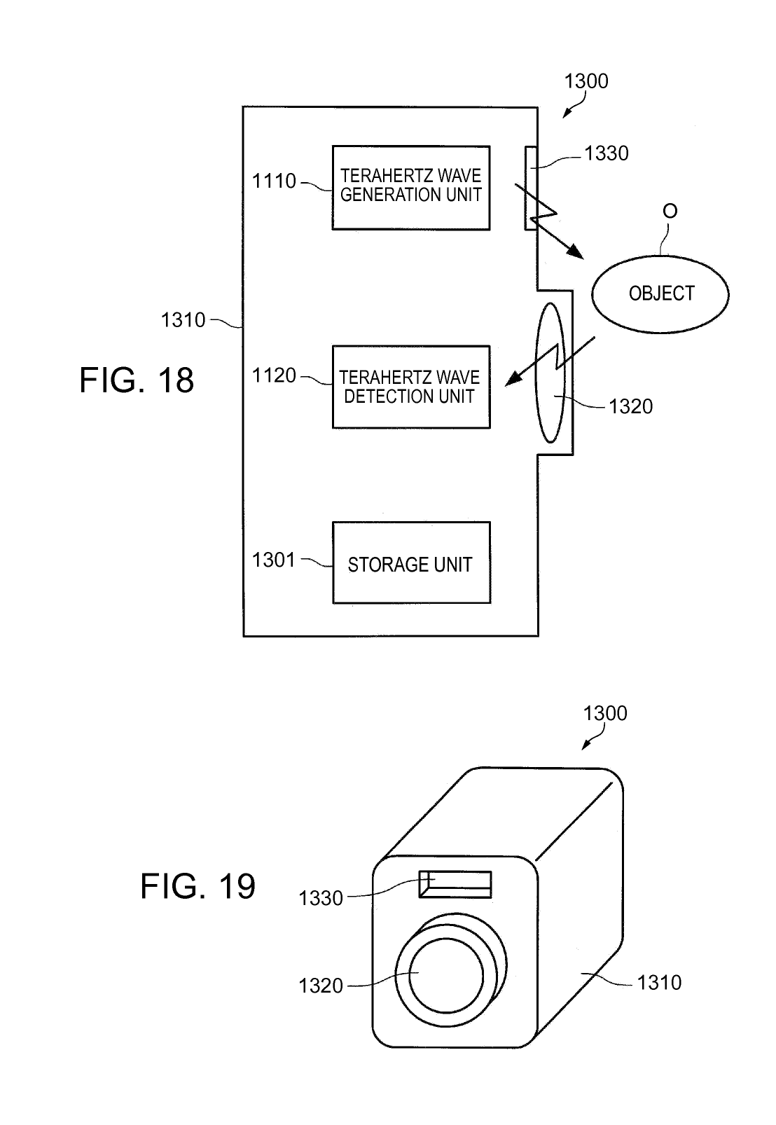

Next, a camera 1300 according to the embodiment will be described referring to the drawings. FIG. 18 is a block diagram showing the camera 1300 according to the embodiment. FIG. 19 is a perspective view schematically showing the camera 1300 according to the embodiment. In the camera 1300 according to the embodiment described below, the members having the same functions as the component members of the above-described imaging apparatus 1100 are represented by the same reference numerals, and detailed description thereof will not be repeated.

As shown in FIGS. 18 and 19, the camera 1300 includes a terahertz wave generation unit 1110 which generates a terahertz wave, a terahertz wave detection unit 1120 which detects the terahertz wave emitted from the terahertz wave generation unit 1110 and reflected by an object O or the terahertz wave transmitted through the object O, and a storage unit 1301. The respective units 1110, 1120, and 1301 are housed in a housing 1310 of the camera 1300. The camera 1300 includes a lens (optical system) 1320 which converges (images) the terahertz wave reflected by the object O to (on) the terahertz wave detection unit 1120, and a window 1330 through which the terahertz wave generated by the terahertz wave generation unit 1110 is emitted to the outside of the housing 1310. The lens 1320 or the window 1330 is made of a member, such as silicon, quartz, or polyethylene, which transmits or refracts the terahertz wave. It should be noted that the window 1330 may have a configuration in which only an opening, such as a slit, is provided.

Next, a use example of the camera 1300 will be described. When imaging the object O by the camera 1300, first, the terahertz wave is generated by the terahertz wave generation unit 1110, and the object O is irradiated with the terahertz wave. Then, the terahertz wave reflected by the object O is converged to (imaged on) the terahertz wave detection unit 1120 by the lens 1320 and detected. The detection result is transmitted to and stored in the storage unit 1301. It should be noted that the irradiation of the object O with the terahertz wave and the detection of the terahertz wave reflected by the object O are performed for the entire object O. The detection result may be transmitted to an external apparatus, for example, a personal computer. The personal computer can perform respective kinds of processing based on the detection result.

The above-described embodiment and the modification examples are an example and are not intended to limit the invention. For example, the embodiment and the modification examples may be appropriately combined.

The invention includes configurations which are substantially the same as the configurations described in the embodiment (for example, configurations having the same functions, methods, and results, or configurations having the same purposes and effects). The invention includes configurations in which non-essential parts of the configurations described in the embodiment are replaced. The invention includes configurations which exhibit the same functional effects as the configurations described in the embodiment, or configurations capable of achieving the same objects. The invention includes configurations in which known techniques are added to the configurations described in the embodiment.

The entire disclosure of Japanese Patent Application No. 2013-261389, filed Dec. 18, 2013 is expressly incorporated by reference herein.

What is claimed is:

1. A short optical pulse generator comprising:
an optical pulse generation unit which generates an optical pulse;
a frequency chirping unit which chirps the frequency of the optical pulse; and
a group velocity dispersion unit which produces a group velocity difference according to wavelength in the optical pulse chirped by the frequency chirping unit,
wherein the group velocity dispersion unit includes
a group velocity dispersion medium on which the optical pulse chirped by the frequency chirping unit is incident, and
a first reflection mirror and a second reflection mirror which are provided with the group velocity dispersion medium sandwiched therebetween, and
the optical pulse incident on the group velocity dispersion medium is reflected by the first reflection mirror and the second reflection mirror multiple times and travels in the group velocity dispersion medium.

2. The short optical pulse generator according to claim 1,
wherein antireflection films are provided on an optical pulse incidence surface of the group velocity dispersion medium and an optical pulse emission surface of the group velocity dispersion medium.

3. The short optical pulse generator according to claim 1, further comprising:
a variable mechanism which changes the incidence angle of the optical pulse to the first reflection mirror.

4. The short optical pulse generator according to claim 1, further comprising:
a collimator lens which converts the optical pulse incident on the group velocity dispersion medium to parallel light.

5. The short optical pulse generator according to claim 1,
wherein the group velocity dispersion medium is a glass substrate.

6. A terahertz wave generator comprising:
the short optical pulse generator according to claim 1; and
a photoconductive antenna which generates a terahertz wave when irradiated with a short optical pulse generated by the short optical pulse generator.

7. A terahertz wave generator comprising:
the short optical pulse generator according to claim 2; and
a photoconductive antenna which generates a terahertz wave when irradiated with a short optical pulse generated by the short optical pulse generator.

8. A terahertz wave generator comprising:
the short optical pulse generator according to claim 3; and
a photoconductive antenna which generates a terahertz wave when irradiated with a short optical pulse generated by the short optical pulse generator.

9. A terahertz wave generator comprising:
the short optical pulse generator according to claim 4; and
a photoconductive antenna which generates a terahertz wave when irradiated with a short optical pulse generated by the short optical pulse generator.

10. A camera comprising:
the short optical pulse generator according to claim 1;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
a storage unit which stores the detection result of the terahertz wave detection unit.

11. A camera comprising:
the short optical pulse generator according to claim 2;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
a storage unit which stores the detection result of the terahertz wave detection unit.

12. A camera comprising:
the short optical pulse generator according to claim 3;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
a storage unit which stores the detection result of the terahertz wave detection unit.

13. A camera comprising:
the short optical pulse generator according to claim 4;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
a storage unit which stores the detection result of the terahertz wave detection unit.

14. An imaging apparatus comprising:
the short optical pulse generator according to claim 1;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
an image forming unit which forms the image of the object based on the detection result of the terahertz wave detection unit.

15. An imaging apparatus comprising:
the short optical pulse generator according to claim 2;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
an image forming unit which forms the image of the object based on the detection result of the terahertz wave detection unit.

16. An imaging apparatus comprising:
the short optical pulse generator according to claim 3;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
an image forming unit which forms the image of the object based on the detection result of the terahertz wave detection unit.

17. An imaging apparatus comprising:
the short optical pulse generator according to claim 4;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
an image forming unit which forms the image of the object based on the detection result of the terahertz wave detection unit.

18. A measurement apparatus comprising:
the short optical pulse generator according to claim 1;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
a measurement unit which measures the object based on the detection result of the terahertz wave detection unit.

19. A measurement apparatus comprising:
the short optical pulse generator according to claim 2;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
a measurement unit which measures the object based on the detection result of the terahertz wave detection unit.

20. A measurement apparatus comprising:
the short optical pulse generator according to claim 3;
a photoconductive antenna which generates a terahertz wave when irradiated with a short optical pulse generated by the short optical pulse generator;
a terahertz wave detection unit which detects the terahertz wave emitted from the photoconductive antenna and transmitted through an object or the terahertz wave reflected by the object; and
a measurement unit which measures the object based on the detection result of the terahertz wave detection unit.
